(19) United States
(12) Patent Application Publication
(10) Pub. No.: US 2024/0402515 A1
(43) Pub. Date: Dec. 5, 2024

(54) Eyewear and Temple Tip Core

(71) Applicant: JINS HOLDINGS Inc., Gunma (JP)

(72) Inventors: Kengo FUTAMI, Gunma (JP); Keiichi Asada, Maebashi-shi (JP)

(73) Assignee: JINS HOLDINGS Inc., Gunma (JP)

(21) Appl. No.: 18/676,053

(22) Filed: May 28, 2024

(30) Foreign Application Priority Data
May 30, 2023 (JP) 2023-088556

(51) Int. Cl. G02C 5/16

(52) U.S. Cl. CPC G02C 5/16

(57) ABSTRACT

To provide eyewear in which a shape-memory resin is used, the eyewear being configured to allow a user to easily make a temple tip fit, and being manufactured at a reduced cost. The eyewear comprises: a front; a pair of end pieces arranged at both ends of the front; a pair of temples connected to the pair of end pieces respectively; and a pair of temple tips that are straight and connected to the pair of temples by extending in a longitudinal direction of the pair of temples, the pair of temple tips including straight temple tip cores formed of a shape-memory resin and extending along the longitudinal direction.

### BACKGROUND

### Field

The present invention relates to eyewear and a temple tip core.

### Description of Related Art

There have conventionally been known eyewear in which a shape-memory resin is used for temples (e.g., Japanese Utility Model Application Publication No. H1-157316), eyewear having earpieces in which a shape-memory resin is used (e.g., Patent Publication JP-A-H8-15654), and eyewear in which a shape-memory resin is used for temple tips into which metal temples with core portions are inserted (e.g., Patent Publication JP-A-2003-43426).

### SUMMARY

As to the eyewear in which a shape-memory resin is used according to Japanese Utility Model Application Publication No. H1-157316, Patent Publication JP-A-H8-15654, Patent Publication JP-A-2003-43426, a relatively expensive shape-memory resin is used to manufacture the whole temples including the temple tips in a predetermined shape or to manufacture members covering the temple tips, leading to an increase in the costs of manufacturing the eyewear. Furthermore, Japanese Utility Model Application Publication No. H1-157316, discloses the eyewear designed to allow an ordinary user (wearer of the eyewear) to attain his/her own fitting without having to go to an optician for adjustment, wherein the temple tips of the temples are bent at a predetermined angle in the initial state of shape memory. Since many glasses sold typically have the temple tips thereof bent at a predetermined angle, it is not always easy for users with different facial sizes and shapes and ear shapes to make the temple tips, which are already bent at a predetermined angle, fit by using their own hands.

Therefore, an object of the present invention is to provide eyewear in which a shape-memory resin is used, the eyewear being configured to allow a user to easily make a temple tip fit, and being manufactured at a reduced cost.

Eyewear according to one aspect of the present invention includes: a front; a pair of end pieces arranged at both ends of the front; a pair of temples connected to the pair of end pieces respectively; and a pair of temple tips that are straight and connected to the pair of temples by extending in a longitudinal direction of the pair of temples, the pair of temple tips including straight temple tip cores formed of a shape-memory resin and extending along the longitudinal direction.

According to the present invention, eyewear that are configured to

allow a user to easily make the temple tips fit and are manufactured at a reduced cost can be provided.

### BRIEF DESCRIPTION OF DRAWINGS

FIG. 1 is a perspective view showing an example of glasses 100 according to an embodiment of the present invention from the front side;

FIG. 2 is a photograph showing an example of a temple tip core A obtained by extrusion molding;

FIG. 3 is a photograph showing an example of a temple tip core B obtained by injection molding;

FIG. 4 is a diagram for confirming the initial states of the temple tip cores A, B having a glass transition temperature of 65° C., and deformed states of the same obtained after being stored for 5 minutes at 90° C. and 15 minutes at 90° C.;

FIG. 5 is a diagram for confirming the initial states of the temple tip cores A, B having a glass transition temperature of 75° C., and deformed states of the same obtained after being stored for 5 minutes at 90° C. and 15 minutes at 90° C.;

FIG. 6 is a diagram showing an example of a temple tip core bent 30 degrees;

FIG. 7 is a table showing a result of confirming an unbending angle of each temple tip core in Experiment A;

FIG. 8 is a diagram showing each temple tip core obtained as a result of visually confirming unbending in Experiment A;

FIG. 9 is a table showing a result of confirming an unbending angle of each temple tip core in Experiment B;

FIG. 10 is a diagram showing each temple tip core obtained as a result of visually confirming unbending in Experiment B;

FIG. 11 is a table showing a result of confirming an unbending angle of each temple tip core in Experiment C;

FIG. 12 is a diagram showing each temple tip core obtained as a result of visually confirming unbending in Experiment C;

FIG. 13 is a diagram showing an experimental result of applying a thermal load to the temple tip cores A, B at 70° C. for 24 hours, the temple tip cores having a glass transition temperature of 75° C.; and

FIG. 14 is a diagram showing an example of pre-deformation and post-deformation of temples of the glasses.

### DETAILED DESCRIPTION

Embodiments of the present invention will be described hereinafter in detail with reference to the drawings. However, the embodiments described below are merely exemplary and are not intended to exclude the application of various modifications and techniques not explicitly described below. That is, the present invention can be implemented with various modifications to the extent not departing from the gist of the present invention. In the following drawings, identical or similar parts are indicated with identical or similar symbols. The drawings are schematic and do not necessarily correspond to actual dimensions and proportions. The drawings may include portions where the relationship of dimensions and proportions differ from each other even among the drawings.

### Embodiments

### Eyewear

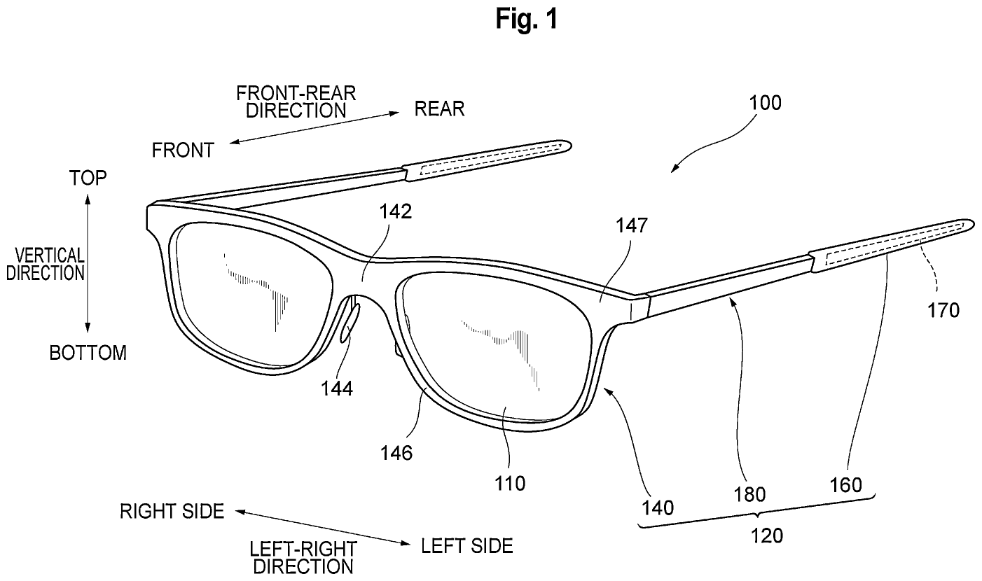

FIG. 1 is a perspective view showing an example of glasses 100 according to an embodiment from the front side. As shown in FIG. 1, the glasses 100 is an example of eyewear, and includes a pair of vision correction lenses 110 and a frame 120. Note that, in the present embodiment, the lenses 110 are described as a pair of lenses but are not necessarily a pair. Also, in the present embodiment, the lenses 110 are described as a configuration of the glasses 100, but the lenses 110 themselves are not configurations necessary for the glasses 100. The eyewear of the present invention can be sunglasses or protective glasses other than vision correction glasses.

The frame 120 includes, for example, a front 140, a pair of temples 180 connected rotatably to both left and right ends of the front 140, and a pair of temple tips 160 attached to rear end of the pair of temples 180. Each of the temple tips 160 includes a temple tip core 170. Further, the frame 120 holds the pair of lenses 110 and holds the lenses 110 and the front 140 in proper positions in relation to the eyes and head of a user.

The front 140 supports the pair of lenses 110. The temples 180, together with the temple tips 160, press temporal parts of the user and sandwich these parts. The temple tip cores 170 contained in the temple tips 160 are formed of a shape-memory resin, and are formed to extend straight along a longitudinal direction of the temples 180 at the time of the manufacture.

As to a method for bending the temple tips 160 according to the present disclosed technique, for example, after the temple tips 160 are immersed in hot water, the temple tip cores 170 made of a shape-memory resin are bent by the user or the like to fit to the shapes of the face and ears of the user. Thus, since the temple tips 160 fittingly come into contact with the upper parts and rear parts of the ears of the user, appropriately preventing the glasses 100 from falling.

In the above description, for the sake of convenience, a longitudinal direction of the front 140 shown in FIG. 1 is referred to as “left-right direction.” When the glasses 100 are worn, the left side from the user's perspective is referred to as “left side,” and the right side from the user's perspective is referred to as “right side.” Also, a short direction of the front 140 is referred to as “vertical direction,” wherein the upward direction of the head is referred to as “upper side” and the downward direction of the head is referred to as “lower side.” A thickness direction of the front 140 is referred to as “front-rear direction,” wherein the front 140 side is referred to as “front side” and the temple tip 160 side is referred to as “rear side.”

Note that the glasses 100 to which the present embodiment is applied are formed to be symmetrical with respect to a bridge 142. Therefore, the following descriptions are provided by giving reference numerals only to the symmetric configurations on either side of the drawings without distinguishing between left and right.

The front 140 is, for example, a plate-like configuration extending in the left-right direction, and is curved so as to protrude forward along the facial surface of the user. The front 140 also includes the bridge 142 located in the middle, a pair of nose pads 144 attached to both left and right sides of a rear surface of the bridge 142, a pair of rims 146 formed at both left and right ends of the bridge 142, a pair of end pieces 147 formed and disposed at respective ends of the pair of rims 146, and a pair of first hinge portions (not shown) attached to rear surfaces of the pair of end pieces 147.

The bridge 142 connects the left portion and the right portion of the front 140 (glasses 100). The bridge 142 is also a curved plate-like member, for example, and may be formed of a resin or the like.

The nose pads 144 support the front 140 by sandwiching the nose of the user from both sides, to keep the height and the like of the front 140 in relation to the eyes of the user. Furthermore, the nose pads 144 are of pad arm-type having, for example, resin pad portions and metal support portions. Note that deformations of the pad portions and support portions allow for fine adjustment of the position of the front 140 in relation to the nose and eyes of the user (e.g., distance between the corneal apexes).

The rims 146 hold the lenses 110. Further, the rims 146 are, for example, ring-like members formed along the shape of the lenses 110, and formed of a resin or the like.

The first hinge portions (not shown) are formed in the end pieces 147. The end pieces 147 are, for example, curved plate-like members and formed of a resin or the like.

The first hinge portions function as an example of connecting portions, and connect the temples 180 so as to be rotatable with respect to the front 140, by being combined with second hinge portions (not shown) having a plate-like shape that are formed on the temple 180 side. That is, the first hinge portions and the second hinge portions configure hinges.

The temples 180 are members that are substantially straight or slightly curved to fit the temporal parts. The temples 180 are also rotatably connected so as to be rotatable within a range from a folded position where a sandwiching angle of the temples 180 with the front 140 is the smallest to an opened position where the sandwiching angle with the front 140 is the largest.

The temple tips 160 are in a straight shape so as to be connected to the temples 180 by extending in a longitudinal direction of the temples 180. The temple tips 160 include therein the straight temple tip cores 170 formed of a shape-memory resin and extending along the longitudinal direction. The temple tips 160 may be formed of a cylindrical elastic member such as elastomer and have water resistance and heat resistance. The temple tip cores 170 may be inserted into cylindrical hollows inside the temple tips 160, and the elastic members of the temple tips 160 may cover the temple tip cores 170.

The temple tip cores 170 are formed of a shape-memory resin having thermoplastic polyurethane as a major component, by deforming the shape-memory resin in a rubber state by applying heat at the glass transition temperature (Tg) or higher (e.g., immersing the shape-memory resin in hot water for a predetermined amount of time, taking it out, and deforming it), and thereafter cooling the resultant deformed object to keep the deformed shape; thus, the temple tip cores 170 have the property of returning to the original shape thereof when heated again.

Incidentally, resin products are generally known to deform (deteriorate) over time due to the strain that remains inside the molded article during the molding process, or so-called residual stress. Moreover, shape-memory resins come in a variety of glass transition temperatures, it is necessary to explore a range of appropriate glass transition temperatures in order to keep the temple tips 160 fitted well so that the glasses 100 do not become uncomfortable to wear due to unbending of the temple tip cores 170 caused by use of the glasses 100.

Thus, the inventors have carried out the following experiments on the temple tip cores 170 of the disclosed technique. First, regarding a method for manufacturing the temple tip cores 170, a temple tip core produced by extrusion molding and a temple tip core produced by injection molding were compared in a various ways.

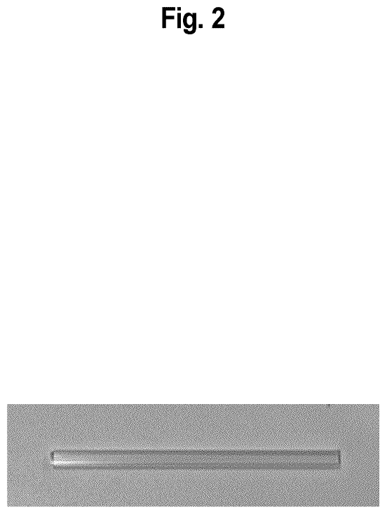

FIG. 2 is a photograph showing an example of a temple tip core A obtained by extrusion molding. The temple tip core A shown in FIG. 2 is manufactured with, for example, a square prism shape of 2 mm in width×3 mm in height×65 mm in length as a target shape.

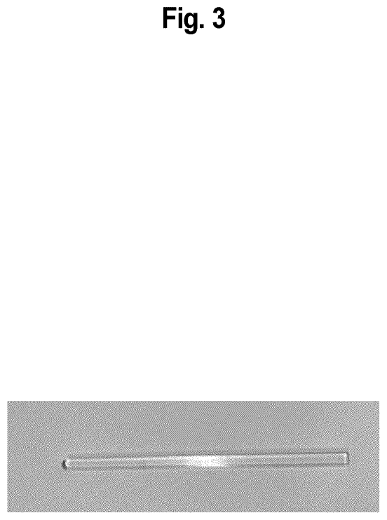

FIG. 3 is a photograph showing an example of a temple tip core B obtained by injection molding. The temple tip core B shown in FIG. 3 is manufactured with, for example, a square prism shape having one end with 2 mm in width×3 mm in height and the other end with 1.6 mm in width×2.6 mm in height, and 65 mm in length as a target shape.

Although the temple tip core A obtained by extrusion molding shown in FIG. 2 and the temple tip core B obtained by injection molding shown in FIG. 3 are manufactured to be identical in terms of the target shape, but the measured values of each of these temple tip cores include a slight margin of error. The difference in shape between the both ends of the temple tip core B is due to a gradient caused when pulling the temple tip core B from the mold in the injection molding, and it is desirable that the shape of the temple tip core B be similar to that of the temple tip core A as much as possible. In the present experiment, “SMP” (Shape Memory Polymer) of SMP Technologies Inc was used as the material of the temple tip cores A and B.

### Thermal Load Experiment

In the present experiment, based on the assumption that the work of heating the temple tip cores 170 for a predetermined amount of time and then bending the temple tip cores 170 when the product was used would be performed a plurality of times, the presence/absence of deformation of the molded article itself when a thermal load was applied thereto was confirmed in order to observe temporal changes in a simulated manner. Specifically, the temple tip cores A and B having glass transition temperatures of 65° C. and 75° C. respectively were stored in a constant temperature machine of 90° C. to visually confirm changes. The temperature 90° C. was obtained based on the assumption that the temple tips 160 (temple tip cores 170) were immersed in hot water for deformation, the hot water being heated by a household electric water boiler to a typical hot water temperature.

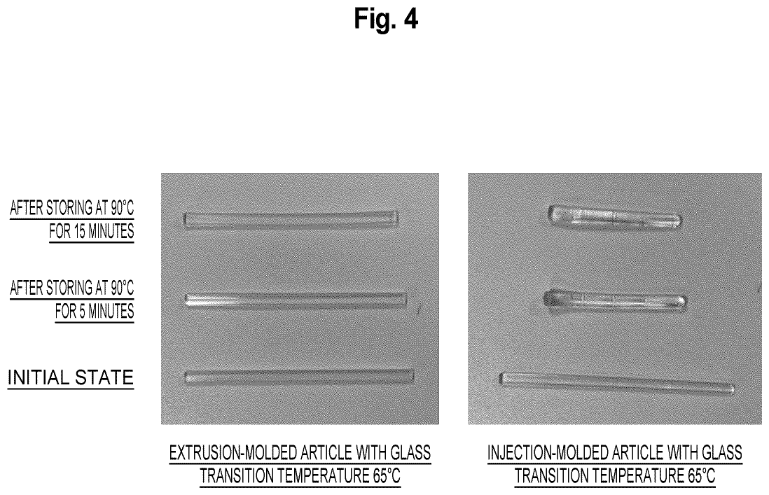

FIG. 4 is a diagram for confirming the initial states of the temple tip cores A, B having a glass transition temperature of 65° C., and deformed states of the same obtained after being stored for 5 minutes at 90° C. and 15 minutes at 90° C. Each of the storage times of 5 minutes and 15 minutes was set based on the assumption that the work of immersing the temple tips at a temperature of 90° C. for 15 to 45 seconds to make them fit (bend) would be performed 20 times, thus calculating 15 seconds×20 times/60 seconds=5 minutes, and 45 seconds×20 times/60 seconds=15 minutes.

In the example shown in FIG. 4, the temple tip core A (extrusion-molded article) with a glass transition temperature of 65° C. is almost undeformed even after being stored at 90° C. for 5 minutes and 90° C. for 15 minutes, as compared to the initial state thereof following the manufacture. The length of the temple tip core A becomes slightly short as the storage time increases, but this is not a problem from the perspective of practical application.

In the example shown in FIG. 4, the temple tip core B (injection-molded article) with a glass transition temperature of 65° C. results in shrinkage in its length into approximately half after being stored at 90° C. for 5 minutes and 90° C. for 15 minutes, as compared to the state thereof following the manufacture. In addition, it can be seen that the temple tip core B with a thermal load applied thereto has deformed in shape, such as from a straight line to slight warpage of an end.

The reason for the shrinkage and deformation of the temple tip core B with a glass transition temperature of 65° C. is considered to be that residual stress tends to remain in the injection molding. In injection molding, it is considered that, since uneven pressure is applied to the shape-memory resin in the process of pouring the shape-memory resin material into the mold and cooling/solidifying it, the residual stress remains in the molded temple tip core B. Therefore, it is considered that the temple tip core B obtained as a result of injection molding shrinks and becomes deformed after thermal load application, due to this residual stress.

On the other hand, the reason that the temple tip core A is almost undeformed is considered to be because extrusion molding does not have the step of applying pressure to the resin inside the mold and cooling/solidifying it, and therefore residual stress is unlikely to remain in the resin at the time of molding the temple tip core.

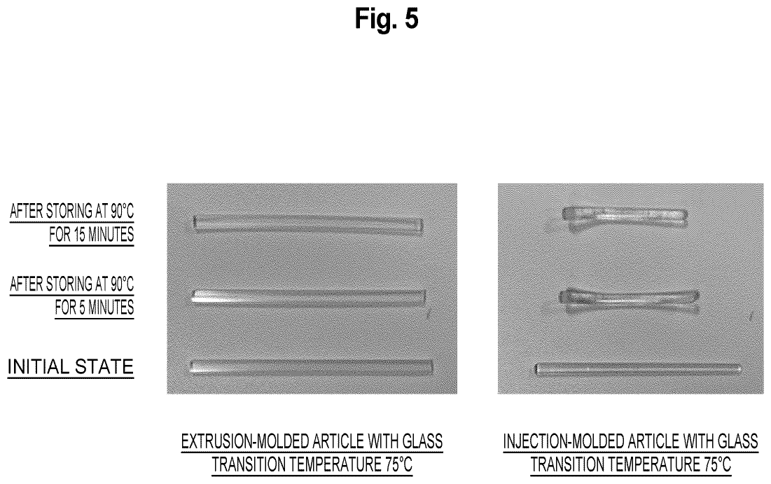

FIG. 5 is a diagram for confirming the initial states of the temple tip cores A, B having a glass transition temperature of 75° C., and deformed states of the same obtained after being stored for 5 minutes at 90° C. and 15 minutes at 90° C. In the example shown in FIG. 5, the temple tip core A (extrusion-molded article) with a glass transition temperature of 75° C. is almost undeformed even after being stored at 90° C. for 5 minutes and 90° C. for 15 minutes, as compared to the initial state thereof following the manufacture. The length of the temple tip core A becomes slightly short as the storage time increases, but this temple tip core has a smaller contraction amplitude than the temple tip core A with a glass transition temperature of 65° C.

In the example shown in FIG. 5, as with the temple tip core B with a glass transition temperature of 65° C., the temple tip core B (injection-molded article) with a glass transition temperature of 75° C. results in shrinkage in its length and deformation such as slight warpage of an end after being stored at 90° C. for 5 minutes and 90° C. for 15 minutes, as compared to the state thereof following the manufacture.

According to the results of the thermal load experiments described above, the temple tip core B, which is an injection-molded article, whether it is a temple tip core with a glass transition temperature of 65° C. or 75° C., may not necessarily be suitable in terms of practical application because the temple tip core B shrinks or becomes deformed from its initial state, depending on the conditions of the thermal load. On the other hand, the temple tip core A, which is an extrusion-molded article, whether it is a temple tip core with a glass transition temperature of 65° C. or 75° C., has more excellent deformation resistance performance than the temple tip core B which is an injection-molded article, only slightly shrinks after thermal load application, and has no problem in terms of practical application. Since the temple tip core A with a glass transition temperature of 75° C. has a smaller contraction amplitude than the temple tip core A with a glass transition temperature of 65° C., it can be said that the former temple tip core A is more suitable in terms of practical application.

### 30-Degree Unbending Experiment

In the present experiment, in order to explore a range of appropriate glass transition temperatures, the temple tip cores 170, which were bent while being applied with heat and then cooled to keep the bent state thereof, were subjected to an experiment for confirming whether unbending to the original shape of the temple tip cores 170 would occur or not by a thermal load with an assumed temperature (body temperature, midsummer temperature, etc.). A temple tip core to be used in the experiment is manufactured by extrusion molding, and is thermally treated and then bent 30 degrees from roughly a central position of the temple tip core by using a predetermined tool. The reason for bending 30 degrees is that a temple tip of eyewear sold in general is bent approximately 30 to 35 degrees based on the longitudinal direction of the temple.

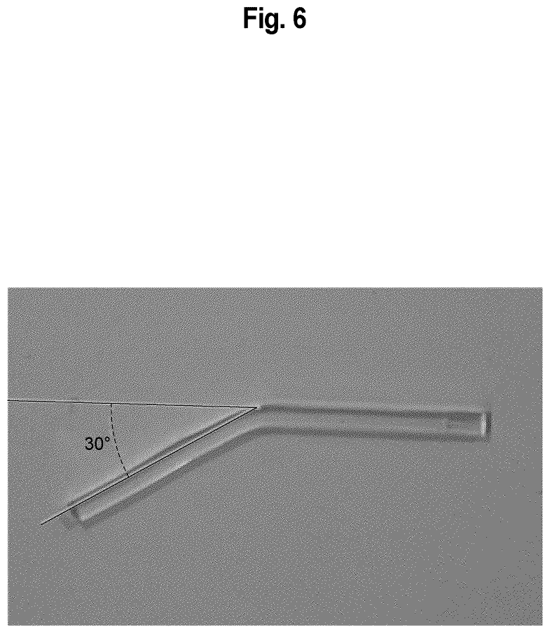

FIG. 6 is a diagram showing an example of the temple tip core bent 30 degrees. Temple tip cores used in the experiment are bent 30 degrees as shown in FIG. 6, and have glass transition temperatures of 45° C., 55° C., 65° C., and 75° C.

For each of the glass transition temperature described above, two temple tip cores were prepared, and the unbending experiment was performed on each of the temple tip cores under the following experimental conditions.

Experiment A: Before and after storage of each temple tip core in a constant temperature machine of 40° C. for 8 hours, visually confirm unbending by angle measurement.

Experiment B: Before and after storage of each temple tip core in a constant temperature machine of 40° C. for 24 hours, visually confirm unbending by angle measurement.

Experiment C: After storage of each temple tip core in a constant temperature machine of 36° C. for 8 hours, take out each temple tip core from the constant temperature machine once, visually confirm unbending by angle measurement, and then return to the constant temperature machine. After storing each temple tip core in the constant temperature machine for 16 more hours (i.e., storage for a total of 24 hours), visually confirm unbending angle measurement.

Note that the period of 8 hours among the storage times corresponds to typical daily usage hours, and the period of 24 hours corresponds to usage hours when used throughout the day. In addition, the temperature of 36° C. among the storage temperatures corresponds to a temperature of a human body, and 40° C. corresponds to a midsummer temperature. Note that the respective temple tip cores used in Experiments A to C are different molded articles prepared for each experiment.

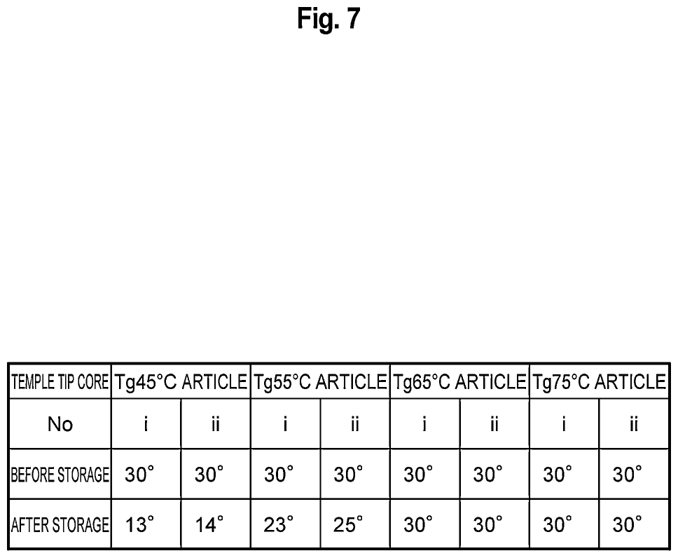

FIG. 7 is a diagram showing a result of confirming an unbending angle of each temple tip core in Experiment A. According to the example shown in FIG. 7, unbending of 13 degrees and 14 degrees occurred in two temple tip cores (Tg 45° C. articles i and ii) with a glass transition temperature of 45° C. after being stored in the constant temperature machine. It can be said that the glass transition temperature was 45° C. with respect to the 40° C. of the constant temperature machine, with the difference therebetween being only 5° C., and that therefore unbending occurred.

Furthermore, slight unbending of 23 degrees and 25 degrees occurred in two temple tip cores (Tg 55° C. articles i and ii) with a glass transition temperature of 55° C. after being stored in the constant temperature machine. The glass transition temperature was 55° C. with respect to the 40° C. of the constant temperature machine, with the difference therebetween being 15° C., and therefore slight unbending occurred.

According to the example shown in FIG. 7, two temple tip cores (Tg 65° C. articles i and ii and Tg 75° C. articles i and ii) with glass transition temperatures of 65° C. and 75° C. respectively were 30 degrees after being stored in the constant temperature machine, and therefore unbending did not occur. It can be said that the glass transition temperatures were 65° C. and 75° C. with respect to the 40° C. of the experimental temperature, which were sufficiently high (the difference therebetween being 25° C. or higher), and that therefore unbending did not occur.

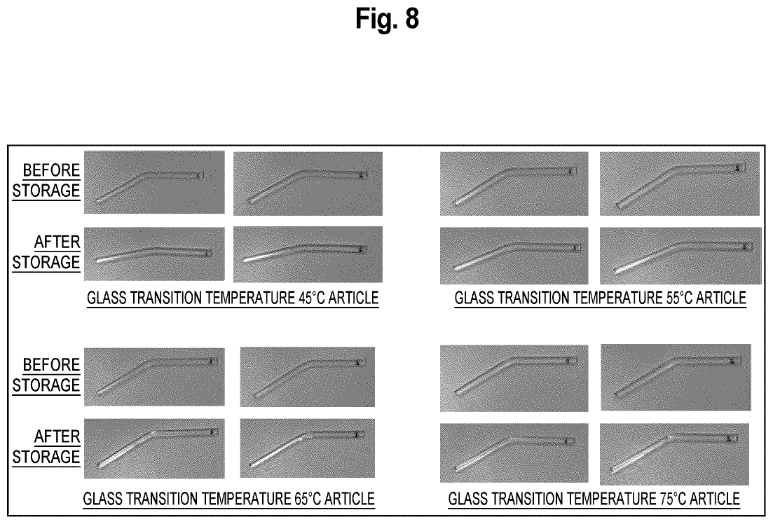

FIG. 8 is a diagram showing each temple tip core obtained as a result of visually confirming unbending in Experiment A. Two temple tip cores with a glass transition temperature of 45° C. shown in FIG. 8 are unbent to a state similar to the initial states (straight shape) thereof. Bending angles of the respective temple tip cores after storage are 13 degrees and 14 degrees, respectively, according to the results shown in FIG. 7.

Two temple tip cores with a glass transition temperature of 55° C. shown in FIG. 8 are slightly unbent. Bending angles of the respective temple tip cores after storage are 23 degrees and 25 degrees, respectively, according to the results shown in FIG. 7. As shown in FIG. 8, slight unbending is confirmed visually.

Two temple tip cores with glass transition temperatures of 65° C. and 75° C. shown in FIG. 8 are not unbent when confirmed visually. Therefore, according to this experiment, unbending occurs when the difference between the assumed temperature of the thermal load and the glass transition temperature is 15° C., and unbending does not occur when the difference is 25° C. Thus, it is highly likely that unbending does not occur if the difference is approximately 20° C. According to the above-described considerations, temple tip cores having a glass transition temperature equal to or higher than the assumed temperature by 20° C. are suitable as the temple tip core of the disclosed technique. Note that the assumed temperature refers to a temperature that is assumed as a thermal load applied to eyewear when the eyewear is used in a typical way.

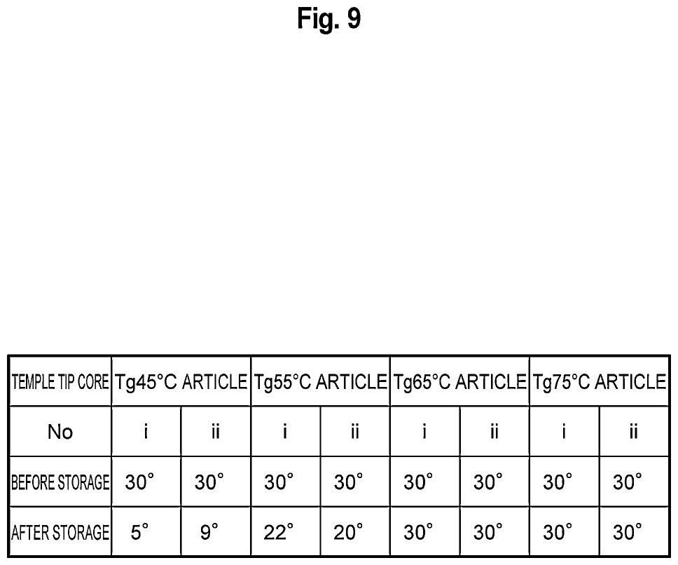

FIG. 9 is a diagram showing a result of confirming an unbending angle of each temple tip core in Experiment B. According to the example shown in FIG. 9, unbending of 5 degrees and 9 degrees occurred in two temple tip cores with a glass transition temperature of 45° C. after being stored in the constant temperature machine. When comparing the results shown in FIG. 7 with the results shown in FIG. 9, it can be understood that extended storage time does not result in linear functional unbending. According to the results shown in FIG. 7, unbending of 16.5 degrees (bending angle (17+16)/2, that is, more than 50% unbending, occurred in 8 hours, and according to the results shown in FIG. 9, unbending of 23 degrees (bending angle (25+21)/2), that is, approximately 77% unbending, occurred in 24 hours.

Moreover, according to the example shown in FIG. 9, compared to the results shown in FIG. 7, more unbending of 22 degrees and 20 degrees occurred in two temple tip cores with a glass transition temperature of 55° C. after being stored in the constant temperature machine. However, as with the temple tip cores with a glass transition temperature of 45° C., extended storage time does not result in linear functional unbending. According to the results shown in FIG. 7, unbending of 6 degrees (bending angle (7+5)/2, that is, 20% unbending, occurred in 8 hours, and according to the results shown in FIG. 9, unbending of 9 degrees (bending angle (8+10)/2), that is, 30% unbending, occurred in 24 hours. Accordingly, it can be understood that significant unbending due to a thermal load occurs during the initial time period of the time in which the thermal load is applied, and thereafter unbending occurs little by little.

According to the example shown in FIG. 9, two temple tip cores with glass transition temperatures of 65° C. and 75° C. are 30 degrees after being stored in the constant temperature machine and show no unbending. It can be said that even when the storage time was extended, the glass transition temperatures were 65° C. and 75° C. with respect to the 40° C. of the experimental temperature, which were sufficiently high (the difference therebetween being 25° C. or higher), and that therefore unbending did not occur.

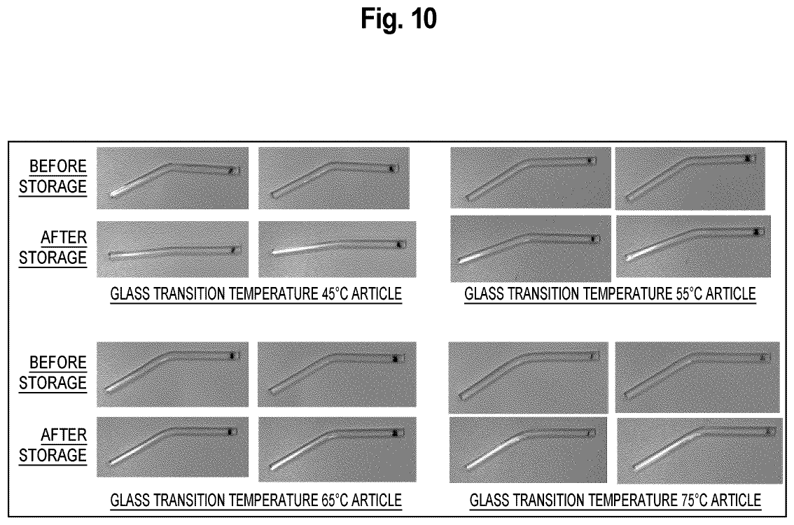

FIG. 10 is a diagram showing each temple tip core obtained as a result of visually confirming unbending in Experiment B. Two temple tip cores with a glass transition temperature of 45° C. shown in FIG. 10 are unbent to a state similar to the initial states (straight shape) thereof. Bending angles of the respective temple tip cores after storage are 5 degrees and 9 degrees, respectively, according to the results shown in FIG. 9.

Two temple tip cores with a glass transition temperature of 55° C. shown in FIG. 10 are slightly unbent. Bending angles of the respective temple tip cores after storage are 22 degrees and 20 degrees, respectively, according to the results shown in FIG. 9. As shown in FIG. 10, unbending is confirmed visually.

Two temple tip cores with glass transition temperature of 65° C. and 75° C. shown in FIG. 10 are not unbent when confirmed visually. Based on Experiments A and B, according to the above-described considerations, temple tip cores having a glass transition temperature equal to or higher than the assumed temperature by at least 20° C. do not become unbent regardless of the storage time, and are therefore suitable as the temple tip core of the disclosed technique.

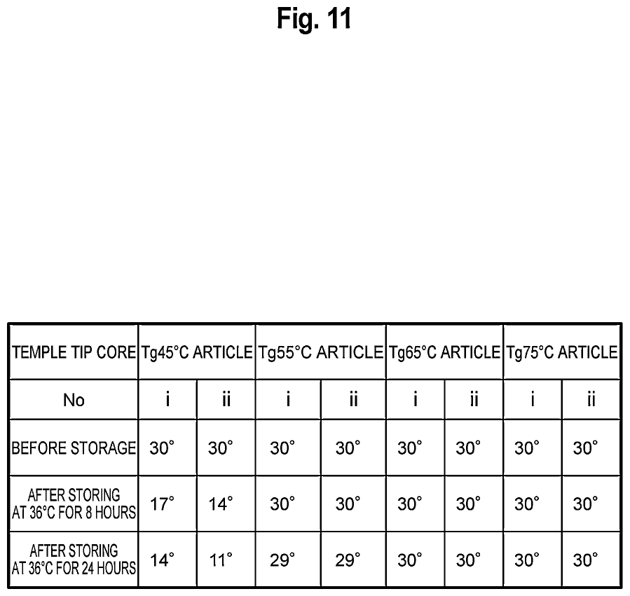

FIG. 11 is a diagram showing a result of confirming an unbending angle of each temple tip core in Experiment C. According to the example shown in FIG. 11, unbending of 17 degrees and 14 degrees occurred in two temple tip cores with a glass transition temperature of 45° C. after being stored in the constant temperature machine for 8 hours, and unbending of 14 degrees and 11 degrees occurred in the two temple tip cores after being stored in the constant temperature machine for 24 hours. It can be said that the glass transition temperature was 45° C. with respect to the 36° C. of the constant temperature machine, with the difference therebetween being approximately 10° C., and that therefore unbending occurred.

According to the example shown in FIG. 11, two temple tip cores with a glass transition temperature of 55° C. were 30 degrees and 29 degrees after being stored in the constant temperature machine for 8 hours and 24 hours respectively, showing almost no unbending. It can be said that the glass transition temperature was 55° C. with respect to the 36° C. of the constant temperature machine, with the difference therebetween being approximately 20° C., and that therefore unbending did not occur. This is consistent with the above-described considerations.

According to the example shown in FIG. 11, two temple tip cores with glass transition temperatures of 65° C. and 75° C. are 30 degrees after being stored in the constant temperature machine for 8 hours and 24 hours, respectively, showing no unbending. It can be said that the glass transition temperatures were 65° C. and 75° C. with respect to the 36° C. of the experimental temperature, which were sufficiently high (the difference therebetween being approximately 30° C. or higher), and that therefore unbending did not occur.

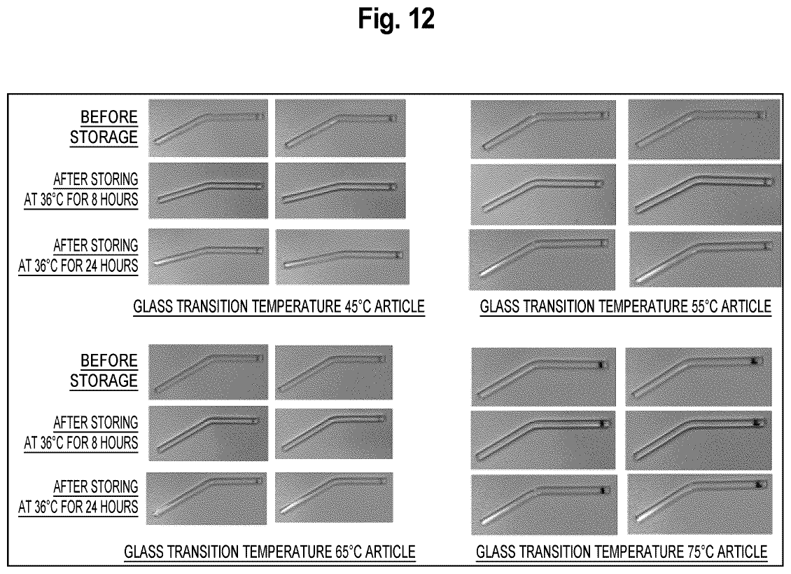

FIG. 12 is a diagram showing each temple tip core obtained as a result of visually confirming unbending in Experiment C. Two temple tip cores with a glass transition temperature of 45° C. shown in FIG. 12 are unbent even when the thermal load was 36° C.

Two temple tip cores with a glass transition temperature of 55° C. shown in FIG. 12 show almost no unbending. Since the thermal load that is applied most constantly during normal use of eyewear is considered to be 36° C., when the assumed temperature is 36° C., the temple tip core with a glass transition temperature of 55° C. is suitable as the temple tip core of the disclosed technique.

Two temple tip cores with glass transition temperature of 65° C. and 75° C. shown in FIG. 12 are not unbent when confirmed visually. According to this experiment, since unbending does not occur in temple tip cores having glass transition temperatures of 55° C., 65° C., and 75° C. with respect to the assumed temperature 36° C., a temple tip core with a glass transition temperature of at least approximately 20° C. is suitable as the temple tip core of the disclosed technique.

### EXAMPLES

According to the results of the thermal load experiment and 30-degree unbending experiment, the following temple tip cores 170 are considered suitable for the disclosed technique. According to a thermal load test, since the temple tip core A obtained by extrusion molding has higher deformation resistance performance than the temple tip core B obtained by injection molding, the temple tip core according to the present disclosure is preferably manufactured by extrusion molding.

According to the results of the 30-degree unbending experiments A to C, the glass transition temperature of the temple tip cores 170 may be determined in accordance with the assumed temperature of the thermal load. For example, the glass transition temperature of the temple tip cores 170 may be included in a range between a first temperature set based on a temperature higher than the temperature of a human body and a second temperature higher than the first temperature. Thus, the glass transition temperature of a mounted component can be determined with clear criteria for the glass transition temperature of the temple tip cores 170.

Further, the first temperature of the temple tip cores 170 may be approximately 55° C. and the second temperature may be approximately 100° C. For example, the temple tip core with a glass transition temperature of 55° C. in Experiment C shown FIG. 11 shows almost no unbending at the assumed temperature of 36° C. Therefore, the temperature of 55° C. as the lower limit of the glass transition temperature is a temperature that may be adopted depending on the assumed temperature of the thermal load. Further, the upper limit 100° C. is the upper limit of a temperature that can be employed as hot water when it is assumed that the temple tips 160 (temple tip cores 170) are immersed in hot water for deformation in a general household.

Further, the first temperature of the temple tip cores 170 may be approximately 65° C. and the second temperature may be approximately 75° C. For example, according to the results of Experiments A and B shown in FIG. 7 and FIG. 9, even when the assumed temperature of the thermal load is 40° C., unbending does not occur as long as the glass transition temperature is at least 65° C. or higher. In addition, by setting the glass transition temperature of the temple tip cores 170 at 75° C. or lower, it is not necessary to prepare hot water having an unnecessarily high temperature.

Further, the glass transition temperature of the temple tip cores 170 may be approximately 75° C. In a case where the assumed temperature of the thermal load is 50° C. in consideration of the rising temperatures and the like in recent years, and when the glass transition temperature is 65° C., the difference therebetween is 15° C., possibly causing unbending according to the results of Experiments A and B shown in FIG. 7 and FIG. 9 (the difference between the assumed temperature 40° C. and the glass transition temperature 55° C. article is 15° C.). However, if the glass transition temperature is 75° C., the difference becomes 25° C., which does not cause unbending according to the results of Experiments A and B shown in FIG. 7 and FIG. 9 (the difference between the assumed temperature 40° C. and the glass transition temperature 65° C. article is 25° C.). Further, since it is sufficient if the difference between the assumed temperature and the glass transition temperature is at least 20° C. or higher, if the assumed temperature is 50° C., a shape-memory resin with a glass transition temperature of 70° C. may be used.

Also, the upper limit of the glass transition temperature of the temple tip cores 170 may be approximately 90° C. The temperature of approximately 90° C. is a temperature of hot water that can be prepared using, for example, household electric water boiler or electric kettle. Therefore, a shape-memory resin with an upper limit of approximately 90° C. with respect to each of the lower limits of the glass transition temperatures may be used.

Further, the glass transition temperature of the temple tip cores 170 may be, for example, approximately 80° C., 85° C., or the like. The glass transition temperature of the temple tip cores 170 may be set in accordance with the assumed temperature of the thermal load.

Also, based on the relationship between the assumed temperature 36° C. and the glass transition temperature 55° C. in Experiment C, it is considered that unbending does not occur easily as long the difference between the assumed temperature and the glass transition temperature is approximately 20° C. In such a case, when the assumed temperature is 40° C. as in Experiments A and B, a shape-memory resin with a glass transition temperature of approximately 60° C. may be used. For example, a shape-memory resin with a temperature range between a glass transition temperature lower limit of approximately 60° C. and a glass transition temperature upper limit of approximately 75, 80, 85, 90, or 100° C. may be used.

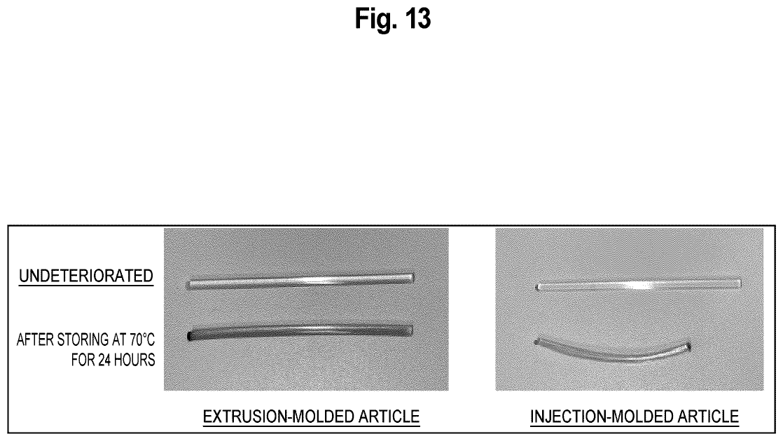

FIG. 13 is a diagram showing an experimental result of applying a thermal load to the temple tip cores A and B at 70° C. for 24 hours, the temple tip cores having a glass transition temperature of 75° C. In the example shown in FIG. 13, temple tip cores obtained before and after the thermal load treatment are shown in the temple tip core A obtained by extrusion molding and the temple tip core B obtained by injection molding. As shown in FIG. 13, warpage due to residual stress can be seen in the temple tip core B obtained by injection molding, but significant deformation cannot be seen in the temple tip core A obtained by extrusion molding.

Here, annealing treatment (annealing) refers to heat treatment in which residual stress of a resin product (resin-molded article or resin material) is removed by the application of heat, the dimensional accuracy is stabilized, and deformation such as distortion and cracking of the resin are prevented. In annealing treatment, since residual stress is removed by applying a thermal load at high temperature (typically higher than a glass transition temperature by 10° C. to 30° C. in case of a crystalline resin containing the shape-memory resin of the disclosed technique) for a predetermined amount of time (e.g., 8 hours), the conditions shown in FIG. 13 and the conditions of the annealing treatment are different from each other but share the same process of removing residual stress. Even under the conditions shown in FIG. 13 that the thermal load is less than the glass transition temperature, the temple tip core B obtained by injection molding has deformed significantly by applying a thermal load for a long period of time, and removing the residual stress upon making into a product is considered difficult. On the other hand, no significant deformation is not observed in the temple tip core A after the thermal load treatment, and based on the above-described results shown in FIG. 4 and FIG. 5 as well, the removal of residual stress by typical annealing treatment is considered doable in the temple tip core A. Thus, the temple tip core A obtained after the annealing treatment is considered more suitable as the temple tip core of the disclosed technique.

Furthermore, the temple tip cores 170 may include a first portion having a glass transition temperature falling within a first temperature range and a second portion having a glass transition temperature falling within a second temperature range. For example, a predetermined portion including the center to be bent as an earpiece may be formed with respect to a lengthwise direction of the temple tip core 170 by using a shape-memory resin having a first glass transition temperature falling within the first temperature range, and portions other than the predetermined portion may be formed with a shape-memory resin having a second glass transition temperature falling within the second temperature range. In addition, an average temperature of the first temperature range may be lower than an average temperature of the second temperature range, satisfying the relation of the first glass transition temperature<the second glass transition temperature.

Thus, the temple tip cores 170 can be provided with parts to be bent and parts not to be bent. For example, when only a portion to be hooked on an ear needs to be bent, the temple tip 160 can be immersed in hot water having a temperature equal to or higher than the first glass transition temperature but less than the second glass transition temperature, and when the entire temple tip core 170 needs to be bent to make it fit to the ear, the temple tip 160 can be immersed in hot water with a temperature equal to or higher than the second glass transition temperature so that the temple tip core 170 can be bent freely. Note that the number of different glass transition temperatures in the temple tip cores 170 may be two, three, or more.

Further, an indicator for a position for immersing the temple tip 160 in hot water may be applied to the temple 180 or temple tip 160. For example, when immersing in hot water from the tip of the temple tip 160 (opposite end of the front 140), an indicator showing how far to immerse is placed on an outer surface of the temple 180 or temple tip 160. The indicator may be any indicator such as a line, a mark, a color, or a pattern that can be identified by the user. Thus, the user can easily see how far to immerse in hot water.

The temple tips 160 may also be configured to be able to identify that the temple tip cores 170 have reached a temperature equal to or higher than a threshold. For example, a thermochromic paint that changes color at the glass transition temperature of the temple tip core 170 or higher, or a thermotape that changes color at the glass transition temperature or higher may be applied to the outer surface of the temple tip 160. Accordingly, after immersing in hot water, the user can see at what point the user can start bending the temple tip 160.

Moreover, for the temple tip core 170, one component may be configured as a straight temple tip core that is formed of a shape-memory resin and included in the temple tip 160 extending and connected in the longitudinal direction of the temple 180 included in the eyewear. Thus, the temple tip core 170 can be manufactured and sold individually.

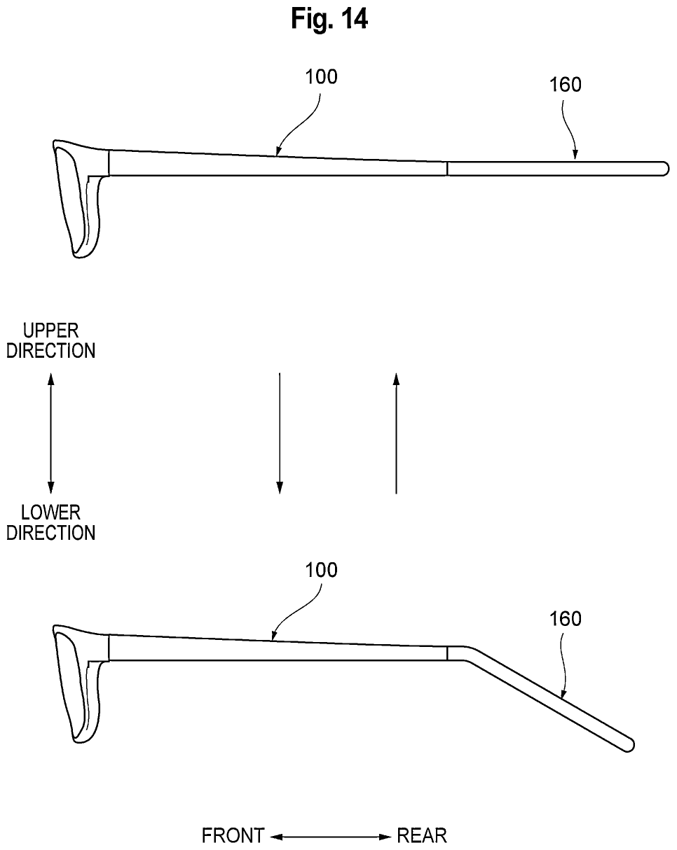

FIG. 14 is a diagram showing an example of pre-deformation and post-deformation of the temple tips 160 of the glasses 100. The upper part of FIG. 14 shows the glasses 100 prior to deformation. The temple tip 160 including the temple tip core 170 extends in the longitudinal direction of the temple and connected thereto.

The lower part of FIG. 14 shows the glasses 100 after deformation. The temple tip 160 including the temple tip core 170 is bent to fit to the ear of the user. For example, the user can immerse the temple tips 160 in hot water, wear the glasses 100 when the user thinks that the temple tip cores 170 has reached a predetermined temperature or higher, and deform the temple tips 160 to make them fit on his/her ears.

Furthermore, by selling the glasses 100 with the temple tips 160 being left straight upon the manufacture, when a typical user with not special skills bends the temple tips 160 initially, the user can easily make the glasses fit depending on the size of his/her face (at what position the user bends) and the shapes of the ears (how much to bend). For example, compared to the prior art in which the glasses with the already bent temple tips are fitted, the straight temple tips 160 allow for a configuration in which, while wearing the glasses 100, the temple tips 160 can be bent in the vertical direction to adjust how well they fit on the ears or can be bent in the left-right direction to adjust the fit to the head. In the disclosed technique, selling the glasses 100 with the temple tips 160 bent is not excluded. The scope of the disclosed technique includes providing the glasses 100 with the temple tip cores 170 straight or bent at the time of the manufacture. That is, the scope of the disclosed technique include any shape, regardless of the shape at the time of sale, as long as the temple tip cores 170 return to the straight initial state thereof when applied with a thermal load.

Additionally, in the disclosed technique, since only the temple tip cores 170 need to be configured with a shape-memory resin, the manufacturing cost can be reduced more compared to the prior art in which the temples and temple tips are integrally made of a shape-memory resin. Since only the temple tip cores 170 can be dealt with independently, partial repair/replacement is possible, reducing the costs of returns and the like. Further, it is desirable that the temple tip cores 170 be straight, and since the temple tip cores 170 can be manufactured by extrusion molding, the incident of defective products due to deformation can be reduced by taking advantage of the properties of the extrusion-molded article having less residual stress. Note that extrusion molding includes molding an article into a straight line from the beginning, and processing a shape-memory resin molded into, for example, a plate shape into a straight line by die cutting, cutting, or the like. The straight line shape may roughly be a linear shape, and even a shape in which, for example, a groove portion is provided between one end and the other end in the longitudinal direction (the cross section perpendicular to the longitudinal direction is in a recessed shape), or a shape in which the resin is partially processed to have a protruding portion to be engaged with the temple tip 160 after extrusion molding, are straight shape as long as they do not depart from the gist of the present invention.

In the relationship between the material of the temple tips 160 and the glass transition temperature of the temple tip cores 170, there can be appropriate combinations. For example, when the glass transition temperature of the temple tip cores 170 is higher than a predetermined temperature (e.g., 80° C.), an appropriate material for the temple tips 160 may be selected in accordance with the glass transition temperature of the temple tip cores 170, such as selecting elastomer with high heat resistance.

Note that the present invention does not exclude the temple tip cores 170 manufactured by injection molding. For example, it is known that deformation due to thermal load can be suppressed by making residual stress even by means of injection compression molding or the like. Further, depending on the combination with the material of the temple tips 160 as well, it is considered that temporal deformation of the injection-molded temple tip core B can be suppressed. Note that temple side end portions of the temple tips 160 and temple tip core side end portion of the temples 180 are removable but may be attached in a fixed manner so as not to come off due to a thermal load.

The present invention has been described above using each embodiment, but the technical scope of the present invention is not limited to the scops described in the foregoing embodiments. It is clear to those skilled in the art that various changes or improvements can be made to the embodiments described above. It is clear from the scope of claims that the technical scope of the present invention includes modes with such various changes or improvements.

1. Eyewear, comprising:
a front;
a pair of end pieces arranged at both ends of the front;
a pair of temples connected to the pair of end pieces respectively; and
a pair of temple tips that are straight and connected to the pair of temples by extending in a longitudinal direction of the pair of temples, the pair of temple tips including straight temple tip cores formed of a shape-memory resin and extending along the longitudinal direction.

2. The eyewear according to claim 1, wherein a glass transition temperature of the temple tip cores is included in a range between a first temperature set based on a temperature higher than a temperature of a human body and a second temperature higher than the first temperature.

3. The eyewear according to claim 2, wherein the first temperature is approximately 55 degree, and the second temperature is approximately 100 degrees.

4. The eyewear according to claim 3, wherein the first temperature is approximately 65 degrees, and the second temperature is approximately 75 degrees.

5. The eyewear according to claim 4, wherein the glass transition temperature of the temple tip cores is approximately 75 degrees.

6. The eyewear according to claim 1, wherein the temple tip cores are manufactured by extrusion molding.

7. The eyewear according to claim 1, wherein the temple tip cores include a first portion having a glass transition temperature falling within a first temperature range and a second portion having a glass transition temperature falling within a second temperature range.

8. The eyewear according to claim 1, wherein an indicator for a position for immersing the temple tips in hot water is added to the temples or temple tips.

9. The eyewear according to claim 1, wherein the temple tips are configured to be able to identify that the temple tip cores have reached a temperature equal to or higher than a threshold.

10. A temple tip core that is straight and formed of a shape-memory resin, the temple tip core being included in a temple tip connected to a temple of eyewear by extending in a longitudinal direction of the temple.

11. The eyewear according to claim 2, wherein the temple tip cores are manufactured by extrusion molding.

12. The eyewear according to claim 3, wherein the temple tip cores are manufactured by extrusion molding.

13. The eyewear according to claim 4, wherein the temple tip cores are manufactured by extrusion molding.

14. The eyewear according to claim 5, wherein the temple tip cores are manufactured by extrusion molding.

15. The eyewear according to claim 2, wherein an indicator for a position for immersing the temple tips in hot water is added to the temples or temple tips.

16. The eyewear according to claim 3, wherein an indicator for a position for immersing the temple tips in hot water is added to the temples or temple tips.

17. The eyewear according to claim 4, wherein an indicator for a position for immersing the temple tips in hot water is added to the temples or temple tips.

18. The eyewear according to claim 5, wherein an indicator for a position for immersing the temple tips in hot water is added to the temples or temple tips.

19. The eyewear according to claim 2, wherein the temple tips are configured to be able to identify that the temple tip cores have reached a temperature equal to or higher than a threshold.

20. The eyewear according to claim 3, wherein the temple tips are configured to be able to identify that the temple tip cores have reached a temperature equal to or higher than a threshold.

21. The eyewear according to claim 4, wherein the temple tips are configured to be able to identify that the temple tip cores have reached a temperature equal to or higher than a threshold.

22. The eyewear according to claim 5, wherein the temple tips are configured to be able to identify that the temple tip cores have reached a temperature equal to or higher than a threshold.
